(19) United States
(12) Patent Application Publication
(10) Pub. No.: US 2018/0075738 A1
(43) Pub. Date: Mar. 15, 2018

(54) Transportation system and method

(71) Applicant: John Van Egmond, Brampton (CA)

(72) Inventor: John Van Egmond, Brampton (CA)

(21) Appl. No.: 15/698,149

(22) Filed: Sep. 7, 2017

Related U.S. Application Data
(60) Provisional application No. 62/394,248, filed on Sep. 14, 2016.

(51) Int. Cl. G08G 1/01; G08G 1/017

(52) U.S. Cl. CPC G08G 1/0112; G08G 1/015; G08G 1/0137; G08G 1/017

(57) ABSTRACT

A transportation system comprises a defined transportation universe having defined contents, authorized vehicles and a defined boundary. There is a central control system. Vehicles each have an identification unit connectable in two-way data communication with the central control system. Each authorized vehicle is powered and self-movable within the transportation universe while controlled by the central system. Authorized vehicles can enter into or exit from the transportation universe through the transportation universe boundary at one of a plurality of entry points or a plurality of exit points respectively. The entry of each vehicle into the transportation universe is authorized by the central control system. Each authorized vehicle is controlled along the journey from entry to exit in co-operation with each other authorized vehicle when in the transportation universe to thereby provide fully collaborative control of traffic in the transportation universe.

### CROSS REFERENCE TO RELATE APPLICATION

This Application claims the filing benefit under 35 U/S/C & 110 [symbol] of U.S. Provisional Application No. 62/394,248 filed Sep. 14, 2016, which is hereby incorporated by reference.

### FIELD OF THE INVENTION

The present invention relates to transportation systems, and more particularly to transportation systems wherein the vehicles within a transportation universe are controlled in a collaborative manner.

### BACKGROUND OF THE INVENTION

The modern vehicle and transportation system is chaotic, large and complex. As such the background herein is limited in scope as the system is well known.

The transportation system for land based systems is characterized by roads, informational devices on the roads, vehicles powered by various energy sources (though predominantly fossil fuels), human drivers, vehicles with safety features (brakes, windows, windshield wipers, speedometers, assistive devices such as cruise control, etc.). To a smaller part autonomous and driverless vehicles which require computers for complex decision making and interaction in a chaotic transportation system are becoming present.

Piloted, autonomous vehicles and other vehicles include safety features related to protecting against accidents and human traumas. The current system is a system of avoidance and competition.

Further, space within the transportation system is poorly used in the way of gaps, bidirectional or multidirectional lanes, intersection, stopping and so on. The transportation system on ground is characterized by informative tools (signs, strips, fences, etc.) to guide users or to hard construct in safety measures. Windshields, windshield wipers, bumpers, advertising signs, law enforcement tools, insurance tools, pavement types, barrier types, signalization, and a host of other tools exist in the vehicle and in the chaotic transportation systems which are not further enumerated herein.

To address safety issues for high speed vehicles and to reduce the interaction of traffic with cross purposes, controlled highways limit access to closed moving vehicles, controlled by means of fences, toll gates, ramps, laws and law enforcement.

The existing fleet of vehicles can include vehicles from almost any era, from horse and carriage to piloted (human or autonomous) vehicles. Many vehicles using the road are decades old.

Current vehicles on land in urban, rural and wild (off-road) settings are piloted and used by humans or autonomous systems to safely navigate to destinations. The pilot (human or computer) must obey traffic laws, navigate safely in the a chaotic transportation system, understand and react to signs, understand and react to signalization, understand and respond to other pilots, understand and react to the signals of other vehicles, and treat other vehicles and obstacles and humans as antagonistic to the optimal route to a destination and to the pilot and to other occupant safety.

Autonomous vehicles currently cannot fully replace the human pilot who needs to be able to override the controls (such as steering or braking). The current vehicle pilot (human or autonomous) operates in a transportation system which experiences many negative outcome interactions which result in injury, death, loss, lost time, wasted energy and wasted greenhouse gas expenditures. The system relies on owners maintaining the thousands of components of the vehicles they own. The system relies on owners maintaining roadways and corridors. The results of negative outcomes are injuries, death, lost time, family grief, loss of income, and other losses such as economic losses which must be insured against.

Further, within the pilot pool and the chaotic transportation system are subversive impaired and distracted drivers who increase the overall chaos and damage. The overarching technical problem is that in the chaotic transportation system the vehicle represents a single unit, protecting itself with diligence and technology from other vehicles in a chaotic transportation system, making all others targets of irrational fears and actions to even the extent of road rage. Further the driver pool includes inexperienced pilots and pilots with diminishing capacity.

The solution to the issues of pilot pools, chaotic systems and the like is to make a transportation universe with vehicles and users within it collaborative and unitary in nature. The invention as disclosed herein sets out the tools and methods of a collaborative transportation universe and collaborative directed destination vehicles.

### BRIEF SUMMARY OF THE INVENTION

In accordance with one aspect of the present invention there is disclosed a novel transportation system comprising a defined transportation universe having defined contents and a defined transportation universe boundary. There is a central control system for controlling the transportation universe. A plurality of vehicles have a vehicle identification unit authorized by the central control system and connectable in two-way data communication with the central control system and is therefore an authorized vehicle. Each authorized vehicle in the transportation universe is controlled by the central computer system interacting with the identification unit in the vehicle. Each authorized vehicle is motor powered so as to be self-movable within the transportation universe under the control of the central control system. Each of the authorized vehicles can enter into the transportation universe through the transportation universe boundary at one of a plurality of entry points and can exit from the transportation universe through the transportation universe boundary at one of a plurality of exit points. The entry of each vehicle into the transportation universe is authorized by the central control system. Each of the plurality of vehicles that enters into and exits from the transportation universe boundary travels a journey between the entry point and the exit point. Each authorized vehicle is controlled along the journey in co-operation with each other authorized vehicle when in the transportation universe to thereby provide fully collaborative control of traffic in the transportation universe.

In accordance with another aspect of the present invention there is disclosed a novel transportation method comprising the steps of defining a transportation universe including contents thereof and a defined transportation universe boundary; programming a central control system to control the transportation universe; providing a plurality of vehicles with a vehicle identification unit authorized by said central control system and connectable in two-way data communication with said central control system, such that said vehicles become authorized vehicles, wherein each authorized vehicle is motor powered so as to be self-movable within the transportation universe under the control of said central control system; controlling each authorized vehicle in the transportation universe using said central computer system; permitting each of said authorized vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and controlling each of said authorized vehicles along said journey in co-operation with each other authorized vehicle when in the transportation universe to thereby provide fully collaborative control of traffic in said transportation universe.

In accordance with another aspect of the present invention there is disclosed a novel computer system comprising one or more servers programmed to communicate with a plurality of vehicles over a communication link for effecting fully collaborative control of traffic in a transportation universe, the one or more servers comprising at least one data processor configured to define a transportation universe including contents thereof and a defined transportation universe boundary; control the transportation universe via a central control system; authorize a plurality of vehicles with having a vehicle identification unit and connectable in two-way data communication with said central control system, such that said vehicles become authorized vehicles, wherein each authorized vehicle is motor powered so as to be self-movable within the transportation universe under the control of said central control system; control each authorized vehicle in the transportation universe using said central computer system; permit each of said authorized vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and control each vehicle along said journey in co-operation with each other authorized vehicle when in the transportation universe to thereby provide fully collaborative control of traffic in the transportation universe.

In accordance with another aspect of the present invention there is disclosed a novel transportation system comprising a defined transportation universe having defined contents and a defined transportation universe boundary. There is a central control system for controlling the transportation universe. A plurality of vehicles have a vehicle identification unit authorized by the central control system and connectable in two-way data communication with the central control system and is therefore an authorized vehicle. Each authorized vehicle in the transportation universe is controlled by the central computer system interacting with the identification unit in the vehicle. Each authorized vehicle is motor powered so as to be self-movable within the transportation universe under the control of the central control system. Each of the authorized vehicles can enter into the transportation universe through the transportation universe boundary at one of a plurality of entry points and can exit from the transportation universe through the transportation universe boundary at one of a plurality of exit points. The entry of each vehicle into the transportation universe is authorized by the central control system. Each of the plurality of vehicles that enters into and exits from the transportation universe boundary travels a journey between the entry point and the exit point. For a predefined path, each authorized vehicle on the predefined pathway is maintained at a predetermined minimum speed to thereby maximize the amount of traffic flow on that predefined path.

In accordance with another aspect of the present invention there is disclosed a novel transportation method comprising the steps of defining a transportation universe including contents thereof and a defined transportation universe boundary; programming a central control system to control the transportation universe; providing a plurality of vehicles with a vehicle identification unit authorized by said central control system and connectable in two-way data communication with said central control system, such that said vehicles become authorized vehicles, wherein each authorized vehicle is motor powered so as to be self-movable within the transportation universe under the control of said central control system; controlling each authorized vehicle in the transportation universe using said central computer system; permitting each of said authorized vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and for a predefined pathway, maintaining the speed of each authorized vehicle on said predefined pathway at a predetermined minimum speed to thereby maximize the amount of traffic flow on that predefined path.

In accordance with another aspect of the present invention there is disclosed a novel computer system comprising one or more servers programmed to communicate with a plurality of vehicles over a communication link for effecting fully collaborative control of traffic in a transportation universe, the one or more servers comprising at least one data processor configured to define a transportation universe including contents thereof and a defined transportation universe boundary; control the transportation universe via a central control system; authorize a plurality of vehicles with having a vehicle identification unit and connectable in two-way data communication with said central control system, such that said vehicles become authorized vehicles, wherein each authorized vehicle is motor powered so as to be self-movable within the transportation universe under the control of said central control system; control each authorized vehicle in the transportation universe using said central computer system; permit each of said authorized vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and maintain the speed of each authorized vehicle along its journey on a predefined pathway at a predetermined minimum speed to thereby maximize the amount of traffic flow on that predefined path.

In accordance with another aspect of the present invention there is disclosed a novel

transportation system comprising a defined transportation universe having defined contents and a defined transportation universe boundary. There is a central control system for controlling the transportation universe. A plurality of vehicles have a vehicle identification unit authorized by the central control system and connectable in two-way data communication with the central control system and is therefore an authorized vehicle. Each authorized vehicle in the transportation universe is controlled by the central computer system interacting with the identification unit in the vehicle. Each authorized vehicle is motor powered so as to be self-movable within the transportation universe under the control of the central control system. Each of the authorized vehicles can enter into the transportation universe through the transportation universe boundary at one of a plurality of entry points and can exit from the transportation universe through the transportation universe boundary at one of a plurality of exit points. The entry of each vehicle into the transportation universe is authorized by the central control system. Each of the plurality of vehicles that enters into and exits from the transportation universe boundary travels a journey between the entry point and the exit point. The central control system can allocate and reallocate the purpose of a predefined pathway in the transportation universe.

In accordance with another aspect of the present invention there is disclosed a novel transportation method comprising the steps of defining a transportation universe including contents thereof and a defined transportation universe boundary; programming a central control system to control the transportation universe; providing a plurality of vehicles with a vehicle identification unit authorized by said central control system and connectable in two-way data communication with said central control system, such that said vehicles become authorized vehicles, wherein each authorized vehicle is motor powered so as to be self-movable within the transportation universe under the control of said central control system; controlling each authorized vehicle in the transportation universe using said central computer system; permitting each of said authorized vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and for a predefined path, allocating and reallocating the purpose of a predefined pathway in the transportation universe.

In accordance with another aspect of the present invention there is disclosed a novel computer system comprising one or more servers programmed to communicate with a plurality of vehicles over a communication link for effecting fully collaborative control of traffic in a transportation universe, the one or more servers comprising at least one data processor configured to define a transportation universe including contents thereof and a defined transportation universe boundary; control the transportation universe via a central control system; authorize a plurality of vehicles with having a vehicle identification unit and connectable in two-way data communication with said central control system, such that said vehicles become authorized vehicles, wherein each authorized vehicle is motor powered so as to be self-movable within the transportation universe under the control of said central control system; control each authorized vehicle in the transportation universe using said central computer system; permit each of said authorized vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and allocate and reallocate the purpose of a predefined pathway in the transportation universe.

The present invention is for collaborative directed destination vehicle control and movement in a defined transportation universe (TU) for the vehicle. The invention includes a collaborative planning tool on board vehicles and as part of the Transportation Universe to direct vehicles from an origin or origins to a destination or destinations without further human intervention. The invention establishes a Transportation Universe. The invention has an interface to allow humans to specify an origin or origins to a destination or destinations.

It is an object of the present invention to provide a transportation universe with vehicles and users within it collaborative and unitary in nature.

It is an object of the present invention to provide a collaborative transportation universe and collaborative directed destination vehicles.

It is an object of the present invention to provide a transportation system and method wherein each authorized vehicle is controlled along said journey in co-operation with each other authorized vehicle when in the transportation universe to thereby provide fully collaborative control of traffic in the transportation universe.

It is an object of the present invention to provide a transportation system and method wherein for a predefined path, each authorized vehicle on the predefined pathway is maintained at a predetermined minimum speed to thereby maximize the amount of traffic flow on that predefined path.

It is an object of the present invention to provide a transportation system and method wherein the central control system can allocate and reallocate the purpose of a predefined pathway in the transportation universe.

It is an object of the present invention to provide a transportation system and method that is not a system of avoidance and competition.

It is an object of the present invention to provide a transportation system and method transportation system wherein travelled pathways are well used in terms of minimizing gaps, bi-directional of pathways, multidirectional lanes, and efficient intersections.

It is an object of the present invention to provide a transportation system and method transportation system wherein humans and autonomous systems are not used to pilot vehicles.

It is an object of the present invention to provide a transportation system and method transportation system that is a non-chaotic transportation system.

It is an object of the present invention to provide a transportation system and method transportation system wherein other vehicles and obstacles and humans are not treated as antagonistic to the optimal route to a destination and to the pilot and to other occupant safety.

It is an object of the present invention to provide a transportation system and method transportation system that minimizes injury, death, loss, lost time, wasted energy and wasted greenhouse gas expenditures.

It is an object of the present invention to provide a transportation system and method transportation system without subversive impaired and distracted drivers.

It is an object of the present invention to provide a transportation system and method transportation system without inexperienced vehicle operators (pilots) and vehicle operators (pilots) with diminishing capacity.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the transportation system and method to the present invention, as to its structure, organization, use and method of operation, together with further objectives and advantages thereof, will be better understood from the following drawings in which a presently known embodiment of the invention will now be illustrated by way of example. It is expressly understood, however, that the drawings are for the purpose of illustration and description only, and are not intended as a definition of the limits of the invention. In the accompanying drawings:

FIG. 1 is a diagrammatic view of a collaborative transportation universe and a collaborative destination directed vehicle within it showing the transportation universe boundary (1), the collaborative destination directed vehicle (2), the origin of a trip (3), the destination of a trip (4), a route plan (5), a collaborative transportation trip allocation tool (e.g. AI, expert system, computer) (6), a destination entry device (7), and a universe bounding marker (8);

FIG. 2 is an enlarged diagrammatic view of FIG. 1 showing the collaborative Transportation Universe with multiple origins (3), destinations (4), multiple vehicles (2), vehicles being aggregated into flocks (203) of common destination, and individual paths (5) to the current trip optimum destination path (5);

FIG. 3 is a diagrammatic view of the collaborative transportation universe showing definitions of the edges of the transportation universe (1 of FIG. 1) showing a multi-parameter data field marker (virtual or real)(8), and the collaborative transportation trip allocation tool (6 of FIG. 1), markers within the transportation universe, which markers include data functions, f(302), and a boundary (9) of the transportation universe;

FIG. 4 is a diagrammatic view of a vehicle (2) with an attachable personal data and trip key (400) and shows a personal local universe definition device (401) used to define a local universe (402) for attachment to the transportation universe and which informs the data and trip key and the transportation universe via the collaborative transportation trip allocation device (6), showing a multi-parameter data field marker (virtual or real)(8) and showing a personal local universe marker (virtual or real) (303) in the transportation universe and a boundary of the collaborative, along with the personal local universe (402) within the transportation universe attached to the transportation universe boundary (9) and the direct connections points by way of the markers (8);

FIG. 5 is a diagrammatic view of the vehicle (2), in the personal local universe (402) within the transportation universe (1), with direct connection points by way of the markers (303,8) also shown, with the direct connection points are at the markers while the lines connecting the points are defined between the markers and are defined by functions f(302);

FIG. 6 is a diagrammatic view of the transportation universe (1) having a collaborative transportation universe boundary (9) and connected to owners and regulators (600), and a local transportation universe (602) that is aggregated with other local transportation universes into the transportation universe (1);

FIG. 7 is a diagrammatic view of Collaborative Directed Destination Vehicles (2) and the Transportation Universe (1), with an environmental conditions station shown (700), and with vehicle (702) being part of a flock as the on board data unit polls by questioning and investigation (701) for road surface conditions from external sources and by such activities as applying brakes, torques, LIDAR distancing, etc. to determine physical conditions and responses, with the data being supplied to the collaborative device (6) and other vehicles on the various paths (5);

FIG. 8 is a diagrammatic view of a collaborative vehicle (2) on a road surface (805) with a collaborative transportation device (6) shown receiving and sending data (802) from an onboard data key value or data key (400) using various equipment (800, 803,804,806);

FIG. 9 is a diagrammatic view of a connection of vehicles (2, 902) that are travelling on a road surface (805) with an interceptor connector (900) shown on vehicle (2) and an approach connector (901) shown on vehicle (902);

FIG. 10 is a diagrammatic view the interceptor connector (900) and its basic components, the interceptor fitting (1001) which mediates the positioning and the transition assistor (1000) which smoothens the interception and connects to a vehicle (2), and the approach connector (901), the approach fitting (1002) and the approach assistor which smoothens the interception and connects to a CDDV (902);

FIG. 11 is a diagrammatic view of the transportation universe (1) in relation to a number of typical owners (600, 1100, 1102, 1104, and 1106) with the boundaries of the various owners' jurisdictions shown (601, 1101, 1103, 1105, and 1107); and,

FIG. 12 is a diagrammatic view collaborative destination directed vehicle (2) having an occupancy space (1200) and showing assorted equipment (1201, 1202, 1203, 1204) customizable managed equipment, and also showing an attachable personal data and trip key (400), occupant data and equipment data (1205), and the data connection informing the vehicle of the occupant equipment (1206).

### DETAILED DESCRIPTION OF THE INVENTION

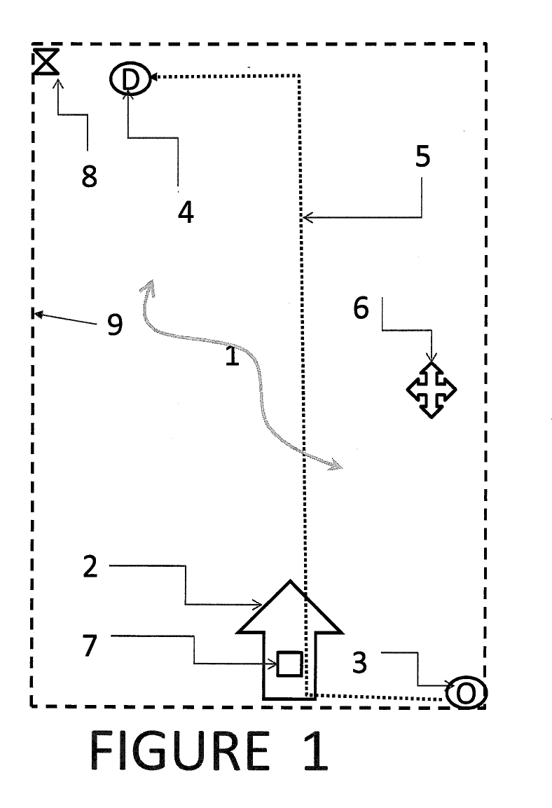

Referring to FIGS. 1 through 12 of the drawings, it will be noted that FIGS. 1 through 12 show a first illustrated embodiment of the transportation system and method according to the present invention.

Reference will now be made to FIGS. 1 through 12, which show a first illustrated embodiment of the present invention. In brief, the first illustrated embodiment of the transportation system (10) comprises a defined transportation universe (1), a central control system (6) (also known as the collaborative trip allocation device), and a plurality of vehicles (2).

FIG. 1 is a view of a collaborative transportation universe (1) and a collaborative destination directed vehicle (2) within it showing the transportation universe boundary (9), the collaborative destination directed vehicle (2), the origin of a trip (3), the destination of a trip (4), a route plan (5), a collaborative transportation trip allocation device (6), a destination entry device (7), and a universe bounding marker (8). The universe (1) consists of a boundary (9) and the bounded space (physical, virtual, em field, etc.) (1 and 9)

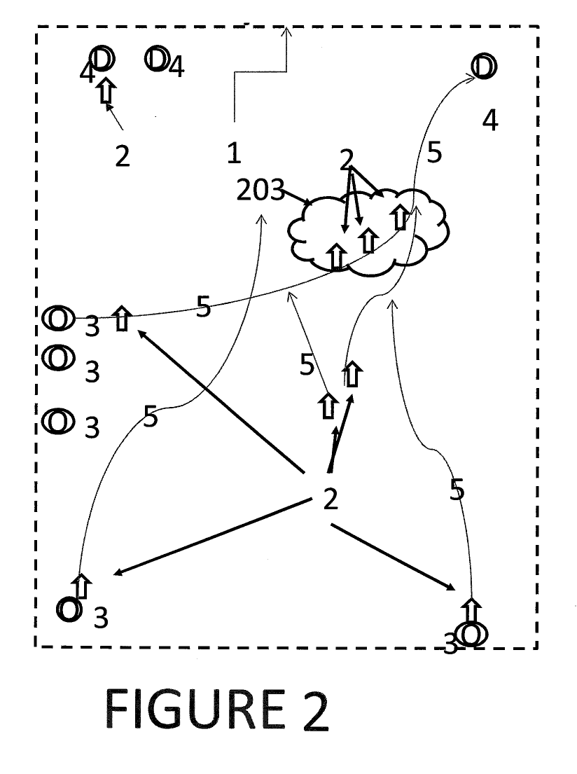

FIG. 2 is an expanded view of FIG. 1 showing the collaborative transportation universe with multiple origins (3), destinations (4), vehicles (2), vehicles being aggregated into flocks (203) of common destination, and individual paths (5) to the current trip optimum destination path (5).

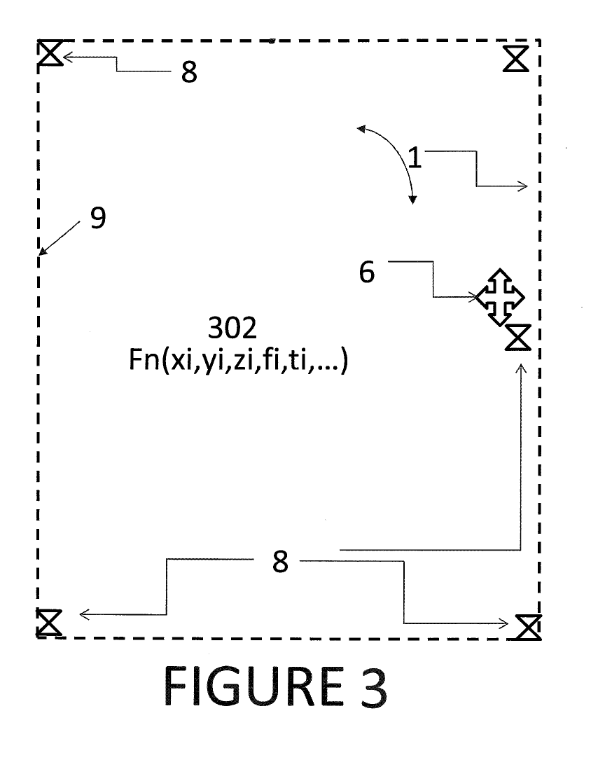

FIG. 3 shows definitions of the edges (9) of the transportation universe (1) of FIG. 1 showing multi-parameter data field markers (8) and the collaborative transportation trip allocation device (6). FIG. 3 shows markers (8) within the TU. The markers include data functions, f(302).

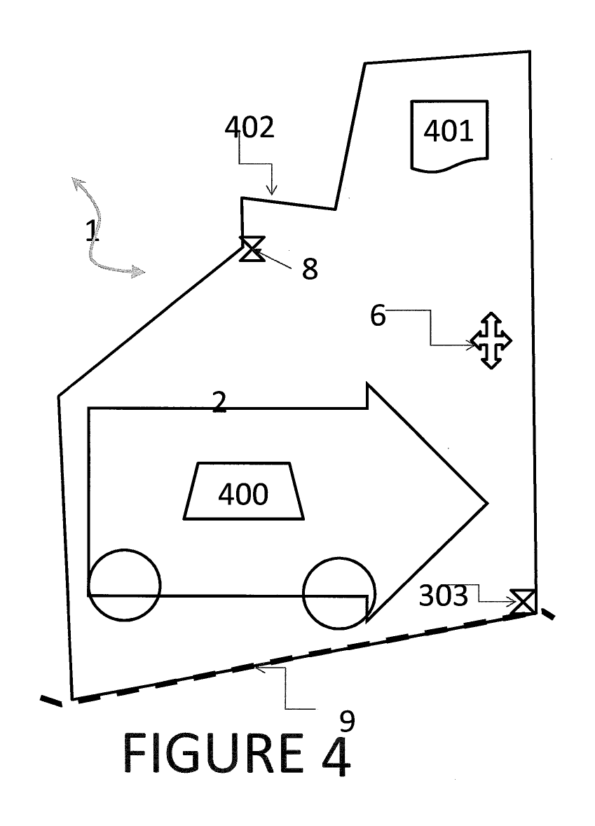

FIG. 4 is a diagrammatic view of a vehicle (2) with an attachable personal data and trip key (400) and shows a personal local universe definition device (401) used to define a local universe (402) for attachment to the transportation universe and which informs the data and trip key and the transportation universe via the collaborative transportation trip allocation device (6). A personal local universe marker (303) in the transportation universe is shown. A boundary of the collaborative transportation universe is shown (9). FIG. 4 shows the person local universe (402) within part of the transportation universe (1). The direct connections points by way of the markers is shown for one marker (303); while in the physical world the points are connected by soil, concrete, wood, and other materials as the physical world has no discontinuities or by virtual markers in the transportation universe. The direct connection points are at the markers while the lines, etc. connecting the points are defined between the markers by functions (302).

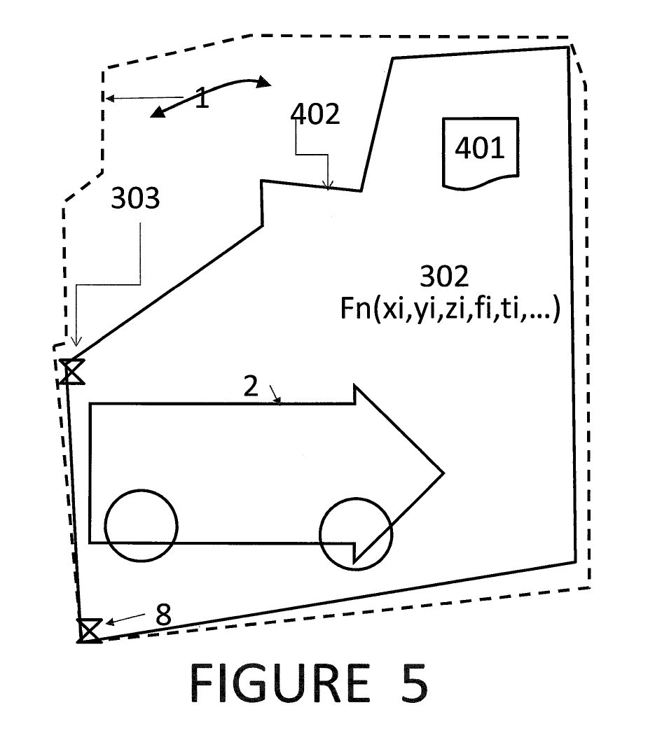

FIG. 5 is a diagrammatic view of the vehicle (2), in the personal local universe (402) within the transportation universe (1), with direct connection points by way of the personal markers (303) and of the system markers (8) also shown, while in the physical world the points are connected by soil, concrete, wood, and other materials as the physical world has no discontinuities or by virtual markers in the transportation universe. The direct connection points are at the markers while the lines, etc. connecting the points are defined between the markers are defined by functions f(302). A personal local universe definition key (401) can allow a human to define a local universe.

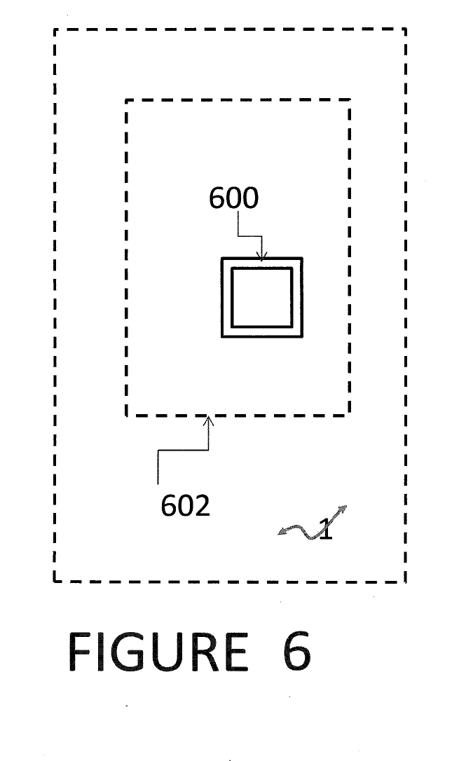

FIG. 6 shows the transportation universe (1) connected to owners and regulators (600). Shown is an owner (600) who owns and controls all rights to a local transportation universe (602), the owner being a person, a business, a government, or other owner type. The local transportation universe is aggregated with other local transportation universes into the transportation universe (1).

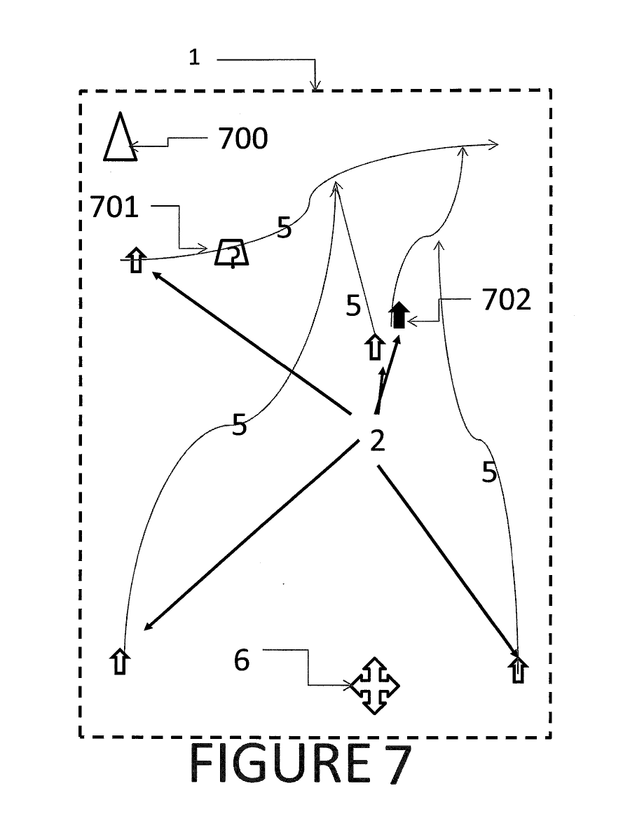

FIG. 7 shows collaborative directed destination vehicles (2) and the transportation universe (1). An environmental conditions station is shown (700). Vehicle (702) is part of an aggregated fleet of vehicles (2) as it polls by questioning and investigation markers, data bases, vehicles (701) for road surface conditions from external sources and by such activities as applying brakes, torques, LIDAR distancing, etc. to determine physical conditions and responses. The data is supplied to the collaborative device (6) and other vehicles on the various paths (5).

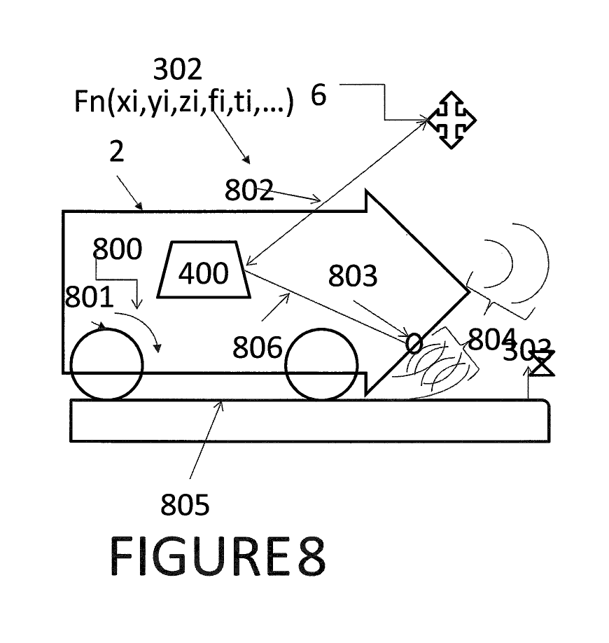

FIG. 8 is a collaborative vehicle (2) on a road surface (805). A collaborative transportation device (6) is shown receiving and sending data from an onboard data key value or data key (400). A signal train (802) moves between the data key (400) and collaborative allocation device (6) with the function data (302). A marker (303) is shown within sensor range in FIG. 8. FIG. 8 further shows the collaborative directed destination vehicle testing road conditions. A torque (800) is applied lightly at a wheel (801). A series of devices (803) (including but limited to or incorporating all LIDAR, infrared, friction wheel, moisture meter, thermometer, radio signal receiver, artificial eye, microphone, GPS signal receiver, energy receiver, time, accelerometer, air pressure meter, and so on) are shown. The devices develops and or receives various data signals (804). The data signals (804) are relayed back to the collaborative data key on a transmission path (wireless, wired, mechanical) (806) to the data key (400).

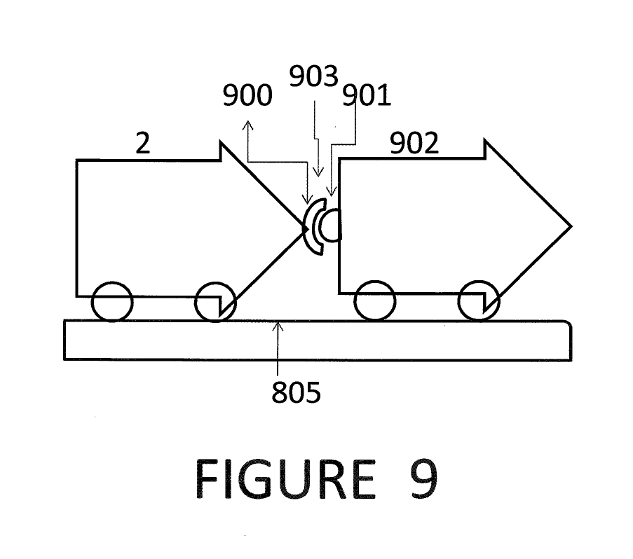

FIG. 9 shows a connection of vehicles (2, 902) that are travelling on a road surface (805). An interceptor connector (900) is shown on one vehicle (2) and an approach connector (901) is shown on another vehicle (902). Connectors are on all four walled surfaces of the vehicles. A connector may be a solid connection (mechanical, magnetic, chemical, glue, rasp, etc) or an air gap mediated by the vehicles (2, 902) and the functions (302), and the collaborative trip allocation device (6). The gap (903) between the connectors may have distance ranging from zero meters to infinity.

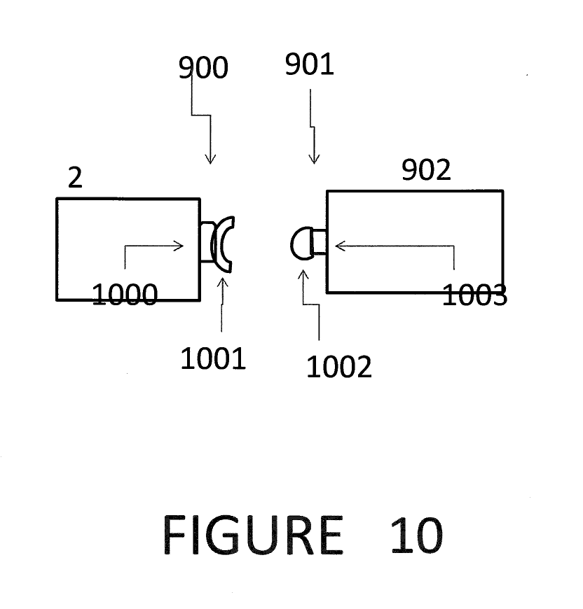

FIG. 10 shows the interceptor connector (900) and its basic components, the interceptor fitting (1001) which mediates the positioning and the transition assistor (1000) which smoothens the interception and connects to a vehicle (2). FIG. 10 shows the approach connector (901), the approach fitting (1002) and the approach assistor which smoothes the interception and connects to a vehicle (902).

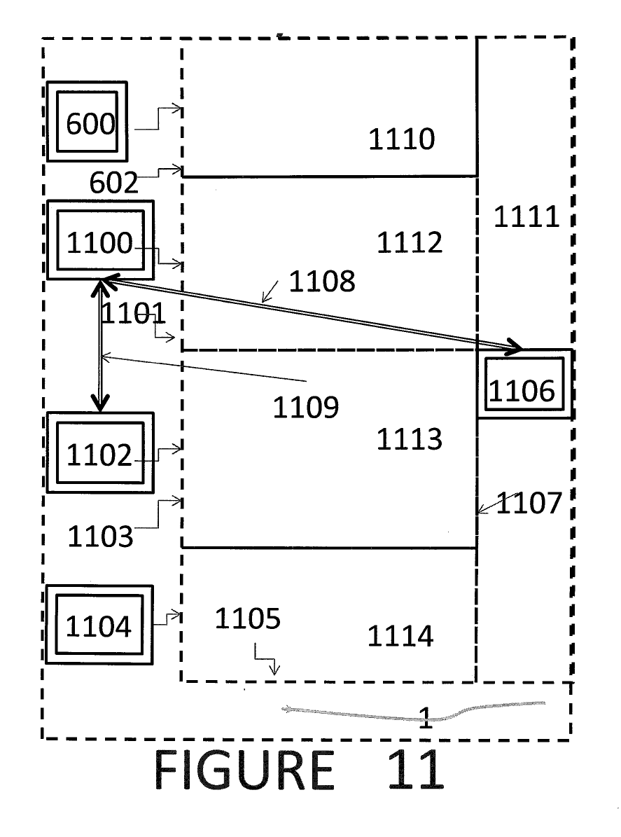

FIG. 11 shows the transportation universe (1) in relation to a number of typical owners (600, 1100, 1102, 1104, and 1106). The boundaries of the various owners' jurisdictions are shown in FIGS. 11 (602, 1101, 1103, 1105, and 1107). The owner respective universes are shown (1110, 1112,1113,1114,1111). 1108 and 1109 shows adjacent owner universes are connected.

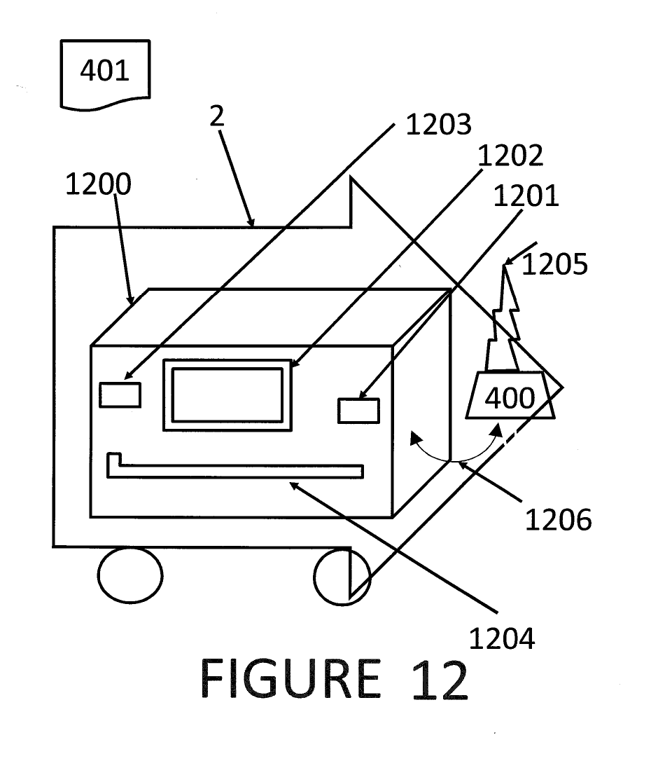

FIG. 12 shows a collaborative destination directed vehicle (2). Within the collaborative destination directed vehicle is an occupancy space (1200). Within the occupancy space, for the benefit and use of passengers are shown assorted equipment (1201, 1202, 1203, 1204) customizable to the owner's preference or need. FIG. 12 shows is an attachable personal data and trip key (400). Occupant data and equipment data (1205) is shown being transmitted. The data connection informing the vehicle of the occupant equipment is shown (1206).

Other variations of the above principles will be apparent to those who are knowledgeable in the field of the invention, and such variations are considered to be within the scope of the present invention. Further, other modifications and alterations may be used in the design and manufacture of the transportation system and method of the present invention, without departing from the spirit and scope of the accompanying claims.

FIG. 1 shows a collaborative Transportation Universe and a Collaborative Destination Directed Vehicle within the collaborative Transportation Universe. FIG. 1 shows the Collaborative Transportation Universe boundary (9), the Collaborative Destination Directed Vehicle (2), an origin of a trip (3), a destination of a trip (4), a route plan (5), and a Collaborative Transportation Trip Allocation device (6), and a destination entry device (7), and universe boundary markers (8).

Referring now to the invention in more detail, in FIG. 1 there is shown a collaborative Transportation Universe, that in the case of land transportation may be considered a collaborative driving universe. The collaborative Transportation Universe consists of private, proprietary, and government owned right of ways. The collaborative Transportation Universe may include parking areas, green space, driving areas, intersections, surfaces, stormwater control devices, toys, articles of clothing, smart markers such as QR codes, bar codes, bridges, underpasses, rail crossings, parking spaces, tools, construction equipment, building boundaries, fences, signs, databases, transmitters, receivers, boundaries, surveys, legal rights of ways, and so on. The collaborative Transportation Universe includes right of ways that are defined by legal metes and bounds, by engineering and other designs, so that the exact shape and configuration are known. The collaborative Transportation Universe can be added to or subtracted from as appropriate. The collaborative transportation is the controlled space in which only collaborative vehicles may operate as vehicles and persons, obstacles, etc. are present only for temporary crossing or use, which persons and obstacles are identified by at least one carried marker.

The markers can be virtual or real (physical pins, decals, radio points, concrete markers, buildings), anything that the Transportation Universe can be identified by and can identify itself by, these are boundaries, either purposely placed or learned. A place boundary marker could be a steel pin, a post with an RFID marker, a wall with a data containing decal. A city might buy 1000 or 20000 decal markers which can be read to the Transportation universe. Once the Transportation universe knows these points, it can check for them, but in storms or if they are destroyed, it remembers them and can act. Homeowners, school boards, business could put them up for their own use, even temporarily to parking could be on a lawn or so parking cannot occur. The owners, schools have personal markers that are owned or controlled by those wishing to connect, though owning the markers will not be an entitlement to connect.

In FIG. 1 the trip allocation device (AI, computer, algorithms, etc.) (6) and all computation and data transmission must be secure.

The Collaborative Transportation Universe in FIG. 1 also includes vehicles (2) so manufactured, vehicles (2) so modified, and other surface occupants. The collaborative Transportation Universe is a defined universe, where the boundaries, space and its occupants are known.

The collaborative Transportation Universe in FIG. 1 also includes markers (8) which serve to define the physical and others dimensions and bounds of the system and which may include survey pins, radiative and acquisition data devices for information in such energy as sound, radio, visible light, heat, light, passive data devices such as signs, stripes, pavement conditions detected by in or extra universe devices, or direct connect communication devices for energy either passively or deliberately for such energy as sound, light, pressure, velocity, and contact pressure.

The collaborative Transportation Universe in FIG. 1 includes an origin (3) where the destination directed collaborative vehicle (2) starts it journey to a destination (4) along a path (5) being guided by the collaborative transportation trip allocation device (6). The collaborative trip allocation device (6) is an AI, algorithm, computer or computers acting collaboratively, communicating with vehicles and boundary indicators (8), transmits and receives data, and collaboratively assigns the path (5) to the destination (4). The collaborative trip allocation device then assigns such matters lanes, spaces, direction, connection, and safety conditions to the collaborative vehicle, stops, starts, speeds, universe loads. The collaborative Transportation Universe might assign all lanes and space to a single direction for example to speed trip times for the path (5).

In FIG. 1, a human wanting to access a vehicle (2) from an origin (3) to a destination (4) uses a destination entry device (7). The device (7) which may include devices such as a data entry tablet, a destination data device plugged into an arrived or parked vehicle, a voice activated command tool, a smart phone or smart device, etc. or an electronic map tool showing a destination is either on board the vehicle (built in) or carried by the human to the vehicle, and may be highly personal (like a wallet) or generic. Whatever tool is used as the directed destination device, once the destination (4) is entered, the Collaborative Destination Directed Vehicle (2) has been directed, and no further control over the vehicle is provided to the occupant except to alter the destination while en route on the path (5) using the destination entry device. Braking, acceleration, lane control, risk allocation, space allocation, lane use, etc. are outside the direct control of the human. Once leaving the origin (3), if the human wants to specify a new destination (4), that can be accomplished using the destination entry device (7). The collaborative Transportation Universe (1) will be a controlled universe so that humans cannot inadvertently enter or exit the CDDV (2) in an unsafe location in the collaborative Transportation Universe, defined by markers (8). Interior or comfort controls may be accessed by the user.

In FIG. 1, the destination device may include alarms to set departure times, transmitted to a device that the person will receive so that a destination arrival time can be planned and priority assigned. Other vehicle controls such as light, heat, air, computers, tablets, entertainment tools, and work tools can integrate into the vehicle.

FIG. 2 shows the general operation of a collaborative Transportation Universe (1). Multiple vehicles (2) represents a plethora of vehicles being aggregated into a flock (203) from different origins (3) to different destinations (4) along multiple paths (5). The collaborative trip allocator decides on such matters as vehicle speed, lane allocation, lane direction, intersection space allocation, connections, safety, collaborative universe conditions, boundary conditions, reliability of existing route data, marker information, and new marker information to plan the trips along paths (5). The aggregated vehicles may be in close proximity or actually touching. Each vehicle was originally assigned a destination (4). The collaborative Transportation Universe assigned the path (5) and the flock formation (203).

In FIG. 3 the boundaries (9) of the collaborative Transportation Universe (1) and the area of the collaborative Transportation Universe are shown. The markers (8) are known or become known to the collaborative trip allocator (6). The data Fn(xi, yi, zi, fi, ti, . . . ) (302) from the markers is assembled and compiled for trip planning, lane planning, vehicle spacing, vehicle speed, destination planning, cross flows, safety, energy usage, and other vehicle, destination, origin, passenger count, etc.

In FIG. 3, the data function f(302) expands or contracts as needed. The markers whether virtual or real, without limiting their location or data methods, may be bare ground, steel or metal boundary markers, on vehicles, posts, persons, on natural boundaries, trees, buildings, in clothing, tools, in boundary plans, in satellite data, in radio station transmissions, pavement markers and on articles carried and worn, and can include information from outside the TU such as aircraft or watercraft locations, the medium the vehicle is in (air, water, land, etc.) and portions of the data f(302) may reside in memory or be shared with other parts of the collaborative Transportation Universe (1). In FIG. 3, a dynamic part of the memory f(302) in the trip allocator remembers current vehicles and trips and past vehicles and trips as well as the associated paths. The data remaining in memory allows the Transportation Universe and collaborative vehicles to learn and further optimize trips, to adapt to systemic or acute changes to the transportation system, destinations, vehicles or those entering upon or being impacted by the transportation system.

In FIG. 4 a vehicle (2) is equipped with an attached or attachable personal data and trip key (400) and or other destination device. FIG. 4 shows a personal local universe definition device (401) used to define a local universe (402). The person in the vehicle has control of the destination using the data entry tool or data key.

The local universe (402) has to be incorporated into the overall universe, whose boundaries are determined by the markers set by the person using the personal local universe definition device (401). It will include the vehicle, the surface, etc. These are set within the geographic context of the universe. If the car moves, the corner points move, if the driveway changes, the markers move. This will be positional, translational, weight, and other matters which can be geographically and parametrically transmitted or stored to the transportation universe (1).

In FIG. 4 the personal local universe definition device (401) must be secure, so that users may know their information is secure and not readily accessible or changeable. The user wants to be sure their universe and vehicle are secure and safe. By loading vehicle statistics, energy use, and the like onto their data key, they can plan trips, maintenance, etc. The transportation universe will check for discontinuities, irregularities (e.g. road into water body or volcano or building).

In FIG. 4 the personal local universe definition key (401) may be used to create a novel new local universe (402) for attachment to the Transportation Universe (1). The personal local universe definition key can be used to describe new markers (303,8) and new data functions f(302) by walking or physical moving the key from marker to marker, by entering data via a tablet, data entry device, smart phone, smart device, etc. by obtaining f(302) from other sources. The personal local universe definition device (401) can allow a human to add a driveway, a parking space, a safe transport pathway, a hazard, a pot holes, etc. to the Transportation Universe and to set conditions. The personal local universe definition key (401) may store the data for temporary use of the Transportation Universe (1) or the trip allocator or it may add the information more permanently.

FIG. 4 shows the personal local universe (402) is connectable to the collaborative Transportation Universe and that the key (401) informs the data and trip key and the Transportation Universe via a collaborative transportation trip allocation device (6).

FIG. 4 shows the personal local universe definition key (401) which can be used by law enforcement, by contractors, by engineers, by public utilities, designers, to make permanent or temporary changes or personal local universes (402) which allow the Collaborative Directed Destination (2) and the Transportation Universe (1) to “understand and implement changes” the changes become known throughout the Transportation Universe (FIG. 1) so that path planning can proceed as shown in FIG. 2.

In FIG. 5 the personal local universe definition is added to the transportation universe (1). The personal local universe definition key (FIG. 3) can be used to describe new markers (303,8) and new data functions f(302) by walking or physically moving the device from marker to marker, by entering data via a tablet, data entry device, smart phone or smart device, etc. by obtaining f(302) from other sources. A personal local universe definition key (401) can allow a human to add a driveway, a parking space, a safe transport pathway, etc. to the transportation universe and to set conditions. The device (401) is used for each add on universe, which could include a vehicle (2) in standard or unusual cases. The device (401) may store the data for temporary use of the transportation universe (1) or trip allocator or it may add the information more permanently. FIG. 5 shows the personal local universe (402) is connectable to the collaborative transportation universe (1) and that the device (401) informs the data and trip key and the transportation universe (1) via a collaborative transportation trip allocation device (6). The connections become markers (3) either physical or defined which the collaborative destination directed vehicle poll for.

Where the collaborative vehicle (FIG. 1, 2) and the Transportation Universe (FIG. 1, 1) finds boundaries, static and dynamic data, etc. used for defining trips seem to involve discrepancies where the marker is outside the universe (but it could involve duplicate data), it can take several courses of action.

The first could include: selecting new paths (see FIG. 2) and the dispatch of an investigator to determine the discrepancy with a personal local universe key device to assist in defining the markers (FIG. 4).

FIG. 6 shows the Transportation Universe (1) connected to owners and regulators (600). Shown is an owner (600) who owns and control all rights to a local Transportation Universe (602), the owner being a person, a business, a government, or other owner type. The owner controls all the lands via direct ownership right, and may erect barriers (physical, legal, social) to define its controls its portion of the Transportation Universe. When the owner cedes functional control, the Transportation Universe adds all information to define new boundaries. While personal local universe (402) and devices (401) can and will be used (see FIGS. 4 and 5), the owner controls include legislated limits, design practices, control, enforcement, risk reduction, crisis intervention, and the like. When these are added to the Transportation Universe, and all owners are added either by design or route interrogation, an aggregated collaborative Transportation Universe can be defined and used.

FIG. 7 shows Collaborative Directed Destination Vehicles (3) and the Transportation Universe (1). Path decisions are made based on the directed destination and path parameters. A Collaborative Directed Destination Vehicle (2) can be used to poll road conditions. A pavement condition system (temperature, moisture, etc.) can further interrogate and inform the Collaborative Directed Destination and the Transportation Universe. A weather station or network (700) collects environmental conditions station. FIG. 7 shows a vehicle (702) part of an aggregated fleet as it polls by questioning and investigation for road surface conditions from external sources and by such activities as applying brakes, torques, LIDAR distancing, etc. to determine physical conditions and responses. The data from the various devices and tools (700, 701, and 702) and other data polling are supplied to the collaborative device (6) and other vehicles on the various paths (5). The device (701) is a device that polls for information in the transportation universe (1), while the device (702) is the vehicle which has a polling device on it (eg. Thermometer, moisture meter). Each vehicle will have appropriate sensor or data deriving device (700, 701, and 702).

FIG. 8 shows a collaborative vehicle (2) on a road surface (805). A collaborative transportation device (6) is shown receiving and sending data from an onboard data key value or data key (400) with data stream (802). The devices that can be used can measure multiple data types, which includes road conditions, engine conditions, torque being applied, wheel pressures, road smoothness, distance to objects, heat of surfaces, electromagnetic radiation profile of objects, sounds, abrasion, dusts, etc. A torque (800) is applied lightly at a wheel (801). A series of devices (LIDAR, Infrared, friction wheel, moisture meter, thermometer, radio signal receiver, artificial eye, microphone, GPS signal receiver, energy receiver, time, accelerometer, air pressure meter, and so on (803) are shown and data (804) is transmitted and/or received.

FIG. 8 shows a signal train (802) of data from the devices such as (700,701,702 in FIG. 7), 803, 800 between the data key (400) and collaborative allocation device (6) with the function data (302). A marker (303) is shown within sensor (803) range in FIG. 8.

FIG. 8 shows a vehicle (2) testing road conditions. The torque at wheel 801 is measured (800). The various devices receive various data signals (804). The data signals (804) are relayed back to the collaborative data key on a transmission path (wireless, wired, mechanical) (806).

FIG. 9 shows a connection of vehicles (2, 902) that are travelling on a road surface (805). The connection may be by physical separable contact so there are no force induced connections or by means of contact only.

An interceptor connector (900) is shown on one vehicle (2). The connector (900) is shaped or made to accept connection in essentially one direction. The connection may be by contact or by proximity, as may be useful.

An approach connector (901) is shown on another vehicle (902). As vehicle (2) approaches vehicle (902), the adapter is monitored and adjusted. Depending on contact type the vehicle may move in complete collaboration or by a statistical or otherwise mediate separation. The advantage of physical contact can include less use of space, less use of fuel, increased safety, and support of a vehicle that suddenly loses power, and so on. The connecting gap (903) is between the interceptor (900) and the approach (901).

In FIG. 9, connectors may be on all four walled exterior vertical surfaces of the vehicles. A connector may be a solid connection (mechanical, magnetic, chemical, glue, rasp, etc.) or an air gap mediated by the vehicles (2, 902), the functions (302), and the collaborative trip allocation device (6).

Gap (903) mediated vehicle flocks will tend to form when road traffic is sparse or intermittent.

In inclement weather solid connection (903) mediated vehicles will allow for increased stability against wind, rain, ice, fog and the like.

FIG. 10 shows the interceptor connector (900) and it basic components, the interceptor fitting (1001). To reduce the stress on vehicle 2 and occupants, any solid connections must be mediated to reduce impact loads and accelerations. The mediator 1000 may include magnetic cushions, springs, hydraulics, or replaceable impact absorbing materials. By mediating the positioning and the transition assistor (1000) reduces the sense of vehicle connection to occupants. Smoother the interception and connects to a vehicle (2) will improve safety.

FIG. 10 shows the approach connector (901) and the approach fitting (1002). To reduce the stress on vehicle 902 and occupants, any solid connections must be mediated to reduce impact loads and accelerations. The mediator 1003 may include magnetic cushions, springs, hydraulics, or replaceable impact absorbing materials. By mediating the positioning and the transition assistor (1002) reduces the sense of vehicle connection to occupants. Smoother the interception and connects to a vehicle (902) will improve safety.

FIG. 11 shows a Transportation Universe (1) in relation to a number of typical owners (600, 1100, 1102, 1104, and 1106) and their local universes (1110, 1112,1113,1114,1111 and so on). Each owner, either by engineering means determines the local boundaries and conditions or by means of the personal local universe tool (FIG. 4, 401).

The boundaries of the various owners' jurisdictions are shown in FIG. 11 (602, 1101, 1103, 1105, and 1107). The total Transportation Universe will change as the jurisdictions change markers, as the director tool and related computers adapt to new data and paths (5) in FIG. 2.

FIG. 12 shows a Collaborative Destination Directed Vehicle (2) within the transportation universe (1) of FIGS. 1 and 2. Within the vehicle (2) is an occupancy space (1200). Within the occupancy space, for the benefit and use of passengers are shown assorted equipment (1201, 1202, 1203, 1204) customizable managed equipment of self-owned/leased/rented/borrowed vehicles and standard for unowned Vehicles (2). The equipment (1201, 1202, 1203, 1204 and the like) make occupancy space suitable for the comfort and use of the occupant.

FIG. 12 shows is an attachable personal data and trip key (400). The personal data and trip key records any equipment and customizable equipment and uses of equipment for the occupants and stores it for use and mediates data (1205) to the outside universe. Equipment data is sent via a connection to the personal data and trip key (401).

The occupant can take the personal data and trip key for use in other vehicles or for later use, or can leave it in the vehicle.

The personal data and trip key (401) of FIG. 4 calculates electrical loads, weights, temperatures, speeds, duration of use, directs power requirements, and provides a data connection for internet and similar services to the outside for the benefit of the occupant of the occupancy space via Collaborative Transportation Trip Allocation device (6) of FIG. 1. Nevertheless, the occupant and occupant space uses, are and remain independent of the planning of the Transportation Universe, the Collaborative Directed Destination Vehicle and the Collaborative Transportation Trip Allocation Device of FIG. 1. The separation is maintained to prevent internal hijacking or external hijacking of the trips, the safety features of the Transportation Universe and the Collaborative Directed Destination Vehicles (2) following the paths from origins to destinations as shown in FIG. 2.

Any changes to the destination of the vehicle are mediated by the occupant control pad, while local universes such as shown in FIGS. 5, 6 and 11 (1110,1111,1112,1113,1114) which attach to the Transportation Universe and other vehicles (2). The separation of the occupancy and the destination planning allows for occupants to use the space as deemed appropriate by them, while allowing the Transportation Universe and Collaborative Directed Destination vehicles to optimize comfort while maintaining safe control over the environment.

In FIG. 12, the occupant, when owning the equipment, merely changes the equipment, comfort, and like equipment and settings. The Collaborative Destination Directed vehicle senses weights, resistances, fuel use, maintenance issues via the Personal Data key. The Personal Data Key informs the occupant of loads that are handled, of user issues constrained by the resources of the vehicle, and the like so that resource allocation may be determined by the Collaborative Destination Directed Vehicle.

The various equipment (1201, 1202, 1203) can be computers, telephones, food devices, beds, chairs, logic gates, mechanical or pneumatic, toys, goods, and so on.

In FIG. 12, the Transportation Universe and Collaborative Destination Directed Vehicles (of FIG. 1) can the transport goods or the other equipment in the occupancy space (1200). A manufacturing firm, a delivery firm, a government or military agency, could thus keep an inventory of the goods being moved and their location within the Transportation Universe while following the paths and aggregations of FIG. 2 from origin to destination. Loading and off-loading can be planned.

Further, the illustrated embodiment transportation system comprises a defined transportation universe (1 FIG. 1) having defined contents and a defined transportation universe boundary (9 FIG. 1) that is defined by markers (8 FIG. 1). At least some of the markers (8) are real, such as posts, road markers, and so on. Also, at least some of the markers (8) are virtual, or in other words, can be co-ordinates in the database of the central control system (6 FIG. 1). Further, at least some of the markers (8) are pre-defined, such as posts, street corners, parking lot boundaries, and so on, while at least some of the markers (8 FIG. 1) are insertable and removable, such as cones, special signs, electronic markers, and so on, and also various types of virtual markers enterable into the system via a computer, cell phone, or the like. At least some of the insertable and removable markers are insertable and removable by users. A user defines a start or origin location with respect to one or more of the markers (8 FIG. 1).

The central control system (6 various Figures including FIG. 1) is for controlling the transportation universe (1 various Figures including FIG. 1) and comprises a plurality of algorithms, AI, computers, quantum controllers and algorithms, servers interconnected one to the other in data communication relation. The central control system (6 FIG. 1) is programmed to develop a route plan (5 FIG. 1) for each vehicle and control each authorized vehicle (2 FIG. 1) along its journey in co-operation with each other authorized vehicle (2 FIG. 1) when in the transportation universe (1 FIG. 1) to thereby provide fully collaborative control of traffic in the transportation universe (1 FIG. 1). In determining a route plan, the central control system (6 FIG. 1) not only considers the vehicles (2, FIG. 1) and the various possible routes, but also considers unplanned obstacles, including unplanned obstacles that suddenly appear and/or move, including bicycles, pedestrians, pedestrians with walkers, baby bunnies, construction, debris, and so on.

The plurality of vehicles comprises various types of vehicles capable of being moved through the transportation universe (1 FIG. 1) by the central control system (6 FIG. 1). Each vehicle has a vehicle identification unit authorized by the central control system (6 FIG. 1) and is connectable in two-way data communication with the central control system and is therefore an authorized vehicle (2 FIG. 1). Preferably, each authorized vehicle (2 FIG. 1) is motor powered so as to be self-movable within the transportation universe (1 FIG. 1) under the control of the central control system (6). It is envisioned that it is possible to have a subsystem within the transportation universe (1 FIGS. 1 and 2) that itself moves non-motor-powered vehicles along (such as non-motorized bicycles, horse-drawn buggies, and so on); however, it is contemplated that this would most likely be uncommon. It should be understood that vehicles such as streetcars and subways, and the like, that typically derive their power from an external source, are still motor powered and fully controllable by an external computer system such as the central control system (6).

Each authorized vehicle (2 FIG. 1) in the transportation universe (1 FIG. 1) is controlled by the central computer system (AI, etc.) interacting with the identification unit in the vehicle. No authorized vehicle in the transportation universe operates autonomously.

Some of the authorized vehicles (2 FIGS. 1 and 2) are privately owned vehicles, such as privately owned cars and the like. Some of the authorized vehicles (2 FIGS. 1 and 2) are corporately owned vehicles, such as rental cars, transport trucks and delivery trucks, and the like. Further, some of the authorized vehicles (2 FIGS. 1 and 2) are publicly owned vehicles, such as buses, streetcars, subways, trains, and the like. It should also be understood that this transportation universe (1 FIG. 1) extends to vehicles that typically do not just travel on land, but also travel in the air and also on water.

Each of the authorized vehicles (2 FIGS. 1 and 2) can enter into the transportation universe (1 FIG. 1) through the transportation universe boundary (9 FIG. 1) at one of a plurality of entry points and can exit from the transportation universe (1 FIG. 1) through the transportation universe boundary (9 FIG. 1) at one of a plurality of exit points. A user starts a journey at the entry point (3 FIG. 1) to the transportation universe (1 FIG. 1), or in other words the origin (3 Figure) of the trip, and ends a journey at the exit point to the transportation universe (1 FIG. 1), or in other words the destination (4 FIG. 1) of the trip.

The entry of each authorized vehicle (2 FIG. 1) into the transportation universe (1 FIG. 1) is authorized by the central control system (6 FIG. 1). In the illustrated embodiment, the entry of each authorized vehicle (2 FIG. 1) into the transportation universe (1 FIG. 1) is authorized by the central control system (6 FIG. 1) on a real time basis.

A user, or the user's cargo, or the like, enters the transportation universe (1 FIG. 1) subsequent to entering an authorized vehicle (2 various Figures including 12). Typically, the entry of each authorized vehicle (2 various Figures including 12) into the transportation universe (1 various Figures including FIG. 1) is invoked by the user, and may be accomplished by the user engaging a destination entry device (7 FIG. 1). The destination entry device (7 FIG. 1) may be a computer system within the authorized vehicle (2 various Figures including FIG. 12), or may be a portable communication device such as a cell phone, or tablet or portable computer, or may be a dedicated device. In a simplified form, the user could enter the transportation universe (1 various Figures including FIG. 1) by pressing a start button on a computer system in the authorized vehicle (2 FIG. 1). Alternatively, a secure form of identification could be used, such as a password or the like, or biometrics (fingerprints, facial recognition, and so on), or an identification card or the like, or an electronic pass code from a portable communication device such as a cell phone, or tablet or portable computer, or a dedicated device.

Each of the plurality of vehicles that enters into and exits from the transportation universe boundary (9 FIG. 1) travels a journey between the entry point and the exit point. At least some, and typically all, journeys are at least partially pre-defined. In other words, when an authorized vehicle (2 FIG. 1) enters the transportation universe (1 FIG. 1), the route of the journey is already preplanned and known. At least some journeys are fully pre-defined.

Each authorized vehicle (2 FIG. 1) is controlled along the journey in co-operation with each other authorized vehicle (2 FIG. 1) when in the transportation universe (1 FIG. 1) to thereby provide fully collaborative control of traffic in the transportation universe (1 FIG. 1). More specifically, each authorized vehicle (2 FIG. 2) is controlled along the journey in co-operation with each other authorized vehicle (2 FIG. 2) when in the transportation universe (1 FIG. 1) by way of automatically spacing each authorized vehicle (2 FIG. 1,9, 10)) from the others, and by way of automatically coupling together at least some of the vehicles together as the vehicles travel on their journeys. Other parameters may also be used to properly control the authorized vehicles (2 FIG. 7,8) along their journeys.

One of the main features of the present invention is that a portion of the authorized vehicles (2 FIG. 2) on a journey in the transportation universe (1 FIG. 2) are defined as a flock of vehicles and the central control system (6 FIG. 1) controls the travel of the flock as one unit along at least a portion of their journeys, and even along the entirety of their journeys.

Typically, but not necessarily, each of the vehicles in the flock of vehicles has a common destination one with the others. Also, or alternatively, the vehicles and a flock may travel together for all or part of the journey. The number of vehicles in the flock of vehicles changes during the journey. An authorized vehicle (2 FIG. 1) can be requested or commanded by a user within the authorized vehicle (2 FIG. 1), or by the central control system (6 FIG. 1,2), to leave a flock at any time during the journey of the authorized vehicle (2, FIG. 2).

The transportation universe (1 various figures including FIG. 11), as illustrated, also includes streets and street intersections. The journey of a first flock and the journey of the second flock that pass through a common intersection, such as a street intersection, are each timed to preclude physical interference of each flock with the other, or in other words, one flock is allowed to pass through the intersection first and the other flock is allowed to pass through the intersection subsequently. It should be understood that the authorized vehicles (2 FIG. 2) in a flock may not be close together, and might even be substantially separated. For instance, they may be starting from separate destinations and travelling to a common destination at different times, but using a common route or uncommon portion of a route. Another scenario is that the authorized vehicles (2 FIG. 2) in a flock may be starting from a common starting point at different times and maybe traveling to the same or different destinations but share a common route for at least part of the journey. The present invention takes advantage of being able to plan a common route, or some common routes for these authorized vehicles (2 FIG. 2) and control the authorized vehicle (2 Various Figures including 2 and 12) similarly, thus allowing for safe coordinated control of authorized vehicles (2 FIG. 2) within the transportation universe (1 various Figures including 1,2,3 11)).

The transportation system universe (1) further comprises personal identification units (401, FIG. 4) authorized by the central control system (6 FIG. 1) and connected in two-way data communication with the central control system (6 FIG. 1), for carrying by individuals entering the transportation universe (1 FIG. 1) without a vehicle. The personal identification units may include a portable data communication device, a physical sensor, a visually readable code, or the like and so on.

The transportation system (1) further comprises a destination data device connectable in two-way data communication with the central control system (6 FIG. 1). As illustrated, the destination data device comprises a data communication device installed in one the authorized vehicles (2 various Figures including FIG. 12). The destination data device stores data regarding at least one destination, and typically stores data regarding various destinations of the user, and can be used in various authorized vehicles (2, various Figures including FIG. 2). The destination data device preferably comprises a portable data communication device, such as a cell phone or tablet, or the like.

The transportation system also further comprises sensors (700 FIG. 7) for monitoring the transportation universe (1 various figures including FIG. 7) and connected to the central control system (6 various figures including FIG. 7) for detecting unauthorized objects in the transportation universe (1 FIG. 1) and providing an object alert to the central control system (6 see for example FIGS. 1 and 8) regarding detected objects. The central control system (6 FIG. 1) uses the object alert to the routes of flocks or changes to routes of flocks.

It is possible for the central control system (6 FIG. 1) to redefine the transportation universe boundary (9 FIG. 1) to accommodate the entry point of a user to the transportation universe (1 Figure). For instance, the transportation universe (1 FIG. 11) might add a new registered user and the coordinates of the new registered users driveway would be entered into the central system, either via computer data entry or physical markers (8 FIG. 1, 303 FIG. 4) placed at the driveway. Also, a registered user of the transportation system universe (1 FIG. 1) that might change a home address or business address, or might add a driveway to a current home address or add a parking lot to a current business address.

The transportation system (1 FIG. 1) further comprises a route evaluation system for evaluating the effectiveness of traveled routes of journeys and producing a route evaluation for various journeys, and comparing various evaluations to develop route optimization data. The route evaluation system is part of the central control system (6 FIG. 1 and other figures) and helps with the optimization of route planning based on historical data.

The central control system (6 FIG. 1 and other figures) can allocate and reallocate the purpose of a predefined pathway, such as a street, in the transportation universe (1 see various Figures including FIG. 11). This allocation and reallocation can be done dynamically, or in other words “on-the-fly”, or can be done on a periodic basis.

The central control system (6 various figures including FIG. 7) can also gather environmental data, such as temperature, weather conditions, road conditions, and so on from at least some of the authorized vehicles (2 FIG. 1), and can use the environmental data to determine the route of an authorized vehicle (2 FIG. 2) or flocks of vehicles.

One other important concept of the transportation system universe according to the present invention is that the central control system can preset the travel speed of vehicles on a predefined pathway and allow the entry of vehicles according to the amount of traffic the predefined pathway. Further restricted entry of vehicles is an important outcome. For instance, on a major highway where the speed limit might be 100 km/h, central control system (6 FIG. 2) might control the authorized vehicle (2) such that the authorized vehicles (2 FIG. 2) travel at 100 km/h, or maybe 90 km/h, even in times of high traffic. This would allow maximum throughput of traffic along the highway, although there might be some delay in getting onto the highway. This is in stark contrast to having traffic over congested on a highway and traveling at perhaps 10 km/h, or even temporarily stopped, thereby not using the highway to its fullest. This would be hugely advantageous in areas that experience severe traffic jams, such as during “rush hour”.

In another aspect, in the illustrated embodiment, the present invention comprises a transportation method comprising the steps of defining a transportation universe (1 FIG. 1) including contents thereof and a defined transportation universe boundary (9 FIG. 1); programming a central control system (6 FIG. 1) to control the transportation universe (1 FIG. 4); providing a plurality of vehicles with a vehicle identification unit authorized by the central control system (6 FIG. 2) and connectable in two-way data communication with the central control system (6 Figures including FIG. 1, 2, 12), such that the vehicles become authorized vehicles (2 FIG. 1), wherein each authorized vehicle (2) is motor powered so as to be self-movable within the transportation universe (1) under the control of the central control system (6); controlling each authorized vehicle (2 Various including FIG. 1) in the transportation universe (1 Various including FIG. 1) using the central computer system; permitting each of the authorized vehicles (2 Various including FIG. 1) to enter into the transportation universe (1) through the transportation universe boundary (9 Various including FIG. 1) at one of a plurality of entry points and to exit from the transportation universe (1 Various including FIG. 1) through the transportation universe boundary (9 Various including FIG. 1) at one of a plurality of exit points; wherein each of the plurality of vehicles that enters into and exits from the transportation universe boundary (9 Various including FIG. 1) travels a journey between the entry point and the exit point; controlling each of the authorized vehicles (2 Various including FIG. 1) along the journey in co-operation with each other authorized vehicle (2 Various including FIG. 1) when in the transportation universe (1 Various including FIG. 1) to thereby provide fully collaborative control of traffic in the transportation universe (1 Various including FIG. 1); for a predefined pathway, maintaining the speed of each authorized vehicle (2 Various including FIG. 1) on the predefined pathway at a predetermined minimum speed to thereby maximize the amount of traffic flow on that predefined path; and for a predefined path, allocating and reallocating the purpose of a predefined pathway in the transportation universe (1 Various including FIG. 1).

In another aspect, in the illustrated embodiment, the present invention comprises a computer system comprising one or more servers programmed to communicate with a plurality of vehicles over a communication link for effecting fully collaborative control of traffic in a transportation universe (1 Various including FIG. 1), the one or more servers comprising at least one data processor configured to define a transportation universe (1 Various including FIG. 1) including contents thereof and a defined transportation universe boundary (9 Various including FIG. 1); control the transportation universe (1 Various including FIG. 1) via a central control system (6); authorize a plurality of vehicles with having a vehicle identification unit and connectable in two-way data communication with the central control system (6), such that the vehicles become authorized vehicles (2 Various including FIG. 1), wherein each authorized vehicle (2 Various including FIG. 1) is motor powered so as to be self-movable within the transportation universe (1 Various including FIG. 1) under the control of the central control system (6); control each authorized vehicle (2 Various including FIG. 1) in the transportation universe (1 Various including FIG. 1) using the central computer system; permit each of the authorized vehicles (2 Various including FIG. 1) to enter into the transportation universe (1 Various including FIG. 1) through the transportation universe boundary (9 Various including FIG. 1) at one of a plurality of entry points and to exit from the transportation universe (1 Various including FIG. 1) through the transportation universe boundary (9 Various including FIG. 1) at one of a plurality of exit points; wherein each of the plurality of vehicles that enters into and exits from the transportation universe boundary (9 Various including FIG. 1) travels a journey between the entry point and the exit point; control each vehicle along the journey in co-operation with each other authorized vehicle (2 Various including FIG. 1) when in the transportation universe (1 Various including FIG. 1) to thereby provide fully collaborative control of traffic in the transportation universe (1 Various including FIG. 1); maintain the speed of each authorized vehicle (2 Various including FIG. 1) along its journey on a predefined pathway at a predetermined minimum speed to thereby maximize the amount of traffic flow on that predefined path; and allocate and reallocate the purpose of a predefined pathway in the transportation universe (1 FIG. 1).

Below are several examples of the collaborative transportation universe. A person, of advanced age, can no longer drive due to slow reaction time in the existing systems. With the collaborative transportation universe, the person calls for a vehicle the person may own, rent, lease etc. and the collaborative transportation universe and vehicle do all the driving.

A person is drunk, but still drives and kills someone in the existing systems. With the collaborative transportation universe, the person and vehicle are brought safely from origin to destination.

A child is crossing the street and is injured by an inattentive driver and its own inattention in the existing system. With the collaborative transportation universe, the child crosses without harm.

A business has customer access and parking areas attached to the existing system where parking and access chaos results. Further the business has to advertise its location with signs and other media. With the collaborative transportation universe, the business connects to the universe, customers come and go smoothly, there is no need for directive signs.

A government plans a new road with stop signs, lanes, signalization, turn lanes, etc in the existing universe. With the collaborative universe the same government designs a road with less lanes, not signals, better safety and related energy and time savings, so the road costs 40% less, energy savings are 30%, and accidents are reduced to near zero as better use is made of space and lanes, while increasing traffic through flow.

A taxi/ride firm provides for hire vehicles, which must navigate the current system. With the collaborative system the vehicles are spread out by the firm at intervals it selects, and customers can access the vehicles easily and the firm can retrieve the vehicle for clean up.

A police officer chases a driver exceeding the speed limit the wrong way on a street in the existing system, resulting in a head on collision and death. With the collaborative transportation universe the vehicle drives the speed limit and there is no chase and no collision and no death, no penalties, no fines, no insurance issues, etc.

A person has a pet needing to go to the vet in the existing system, taking time off work to do so. In the collaborative universe the pet is sent by the person to the vet, which vet does the work, and sends the pet back.

A parent is readying a child for school and must rush to get morning routines done to drive safely to the school and work in the existing system. In the collaborative transportation universe, the parent readies the child and can do portions of the morning routines in the vehicle, saving time and stress.

In each situation above the existing system is one of attentive action by humans, while in the collaborative transportation universe the attentive action is by the universe elements and the attention of the human can be productively used elsewhere. Many more examples will develop but these suffice to show a collaborative transportation universe produces less risks, uses less energy, uses less road space, requires basically little enforcement, and offers other benefits.

### Other Aspects of the Invention

An Aspect of the transportation system is that a user enters the transportation universe subsequent to entering an authorized vehicle unless they are a pedestrian or other natural person not in a vehicle.

An aspect of the transportation system is that the entry of each vehicle into the transportation universe is invoked by said user.

An aspect of the transportation system is that a user enters the transportation universe by engaging a destination entry device.

An aspect of the transportation system is that a user enters the transportation universe by pressing/engaging a start button(s)/device(s).

An aspect of the transportation system is that the central control system uses said object alert to the routes of flocks of vehicles or changes to routes of flocks of vehicles.

An aspect of the transportation system is that there is a destination data device connectable in two-way data communication with the central control system.

An aspect of the transportation system is that the destination data device comprises a data communication device installed in one said authorized vehicles.

An aspect of the transportation system is that the destination data device comprises a portable data communication device.

An aspect of the transportation system is that the destination data device stores data regarding at least one destination, and wherein said data can be used in various authorized vehicles.

An aspect of the transportation system is that the central control system redefines the transportation universe boundary to accommodate the entry point of a user to the transportation universe.

An aspect of the transportation system is that a user defines a start location with respect to one or more of the markers of the boundary of the transportation system.

An aspect of the transportation system is that a user defines a start location with respect to one or more of the markers of the boundary of the transportation system.

An aspect of the transportation system is that an AI or other computer system comprising one or more servers and or computers and or AI programmed to communicate with a plurality of vehicles over a communication link for effecting fully collaborative control of traffic in a transportation universe, the one or more servers comprising at least one data processor configured to:
The computer system defines and it is defined as part of a transportation universe including the contents thereof and a defined transportation universe boundary;
The computer system controls the transportation universe via a central control system;
The computer system authorizes a plurality of vehicles with each having a vehicle identification unit and is connectable in multi-way data communication with said central control system, such that said vehicles become authorized vehicles, wherein each authorized vehicle is motor powered so as to be self-movable within the transportation universe under the control of said central control system;
The transportation universe system controls each authorized vehicle in the transportation universe using said central computer system;
The transportation universe permits each authorized vehicle to enter into the transportation universe through the transportation universe boundary at one of a plurality of entry points and to exit from the transportation universe through the transportation universe boundary at one of a plurality of exit points;
The plurality of vehicles that enters into and exits from the transportation universe boundary travels a journey entirely within the transportation universe between the entry points and exit points.
The transportation universe computer control system controls each vehicle along said journey in co-operation with each other authorized vehicle when in the transportation universe to thereby provide fully collaborative control of traffic in the transportation universe.
A computer system comprising one or more servers programmed to communicate with a plurality of vehicles over a communication link for effecting fully collaborative control of traffic in a transportation universe, the one or more servers comprising at least one data processor configured to:
define a transportation universe including contents thereof and a defined transportation universe boundary;
control the transportation universe via a central control system;
authorize a plurality of vehicles with having a vehicle identification unit and connectable in two-way data communication with said central control system, such that said vehicles become authorized vehicles, wherein each authorized vehicle is motor powered so as to be self-movable within the transportation universe under the control of said central control system;
control each authorized vehicle in the transportation universe using said central computer system;
permit each of said authorized vehicles to enter into the transportation universe through the transportation universe boundary at one of a plurality of entry points and to exit from the transportation universe through the transportation universe boundary at one of a plurality of exit points;
wherein each of said plurality of vehicles that enters into and exits from the transportation universe boundary travels a journey between said entry point and said exit point; and,
maintain the speed of each authorized vehicle along its journey on a predefined pathway at a predetermined minimum speed to thereby maximize the amount of traffic flow on that predefined path.

The transportation system wherein at least some journeys are or may be at least partially pre-defined.

The transportation system wherein at least some journeys are or may be fully pre-defined.

As can be understood from the above description and from the accompanying drawings, the present invention provides a transportation universe with vehicles and users within it collaborative and unitary in nature, provide a collaborative transportation universe and collaborative directed destination vehicles, to provide a transportation system and method wherein each authorized vehicle is controlled along said journey in co-operation with each other authorized vehicle when in the transportation universe to thereby provide fully collaborative control of traffic in the transportation universe, to provide a transportation system and method wherein for a predefined path, each authorized vehicle on the predefined pathway is maintained at a predetermined minimum speed to thereby maximize the amount of traffic flow on that predefined path, to provide a transportation system and method wherein the central control system can allocate and reallocate the purpose of a predefined pathway in the transportation universe, to provide a transportation system and method that is not a system of avoidance and competition, to provide a transportation system and method transportation system wherein travelled pathways are well used in terms of minimizing gaps, bi-directional of pathways, multidirectional lanes, and efficient intersections, to provide a transportation system and method transportation system wherein humans and autonomous systems are not used to pilot vehicles, to provide a transportation system and method transportation system that is a non-chaotic transportation system, to provide a transportation system and method transportation system wherein other vehicles and obstacles and humans are not treated as antagonistic to the optimal route to a destination and to the pilot and to other occupant safety, to provide a transportation system and method transportation system that minimizes injury, death, loss, lost time, wasted energy and wasted greenhouse gas expenditures, to provide a transportation system and method transportation system without subversive impaired and distracted drivers, to provide a transportation system and method transportation system without inexperienced vehicle operators (pilots) and vehicle operators (pilots) with diminishing capacity.

Other variations of the above principles will be apparent to those who are knowledgeable in the field of the invention, and such variations are considered to be within the scope of the present invention. Further, other modifications and alterations may be used in the design and manufacture of the transportation system and method of the present invention, without departing from the spirit and scope of the accompanying claims.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”, “for example”) provided herein, is intended merely to better illuminate embodiments of the invention and does not pose a limitation on the scope of the invention unless otherwise claimed. No language in the specification should be construed as indicating any non-claimed element as essential to the practice of the invention.

Another aspect of transportation method is that it comprises the steps of:
defining a transportation universe including contents thereof and a defined transportation universe boundary;
programming a central control system to control the transportation universe;
providing a plurality of vehicles with a vehicle identification unit authorized by said central control system and connectable in two-way data communication with said central control system, such that said vehicles become authorized vehicles, wherein each authorized vehicle is motor powered so as to be self-movable within the transportation universe under the control of said central control system;
controlling each authorized vehicle in the transportation universe using said central computer system;
permitting each of said authorized vehicles to enter into the transportation universe through the transportation universe boundary at one of a plurality of entry points and to exit from the transportation universe through the transportation universe boundary at one of a plurality of exit points;
wherein each of said plurality of vehicles that enters into and exits from the transportation universe boundary travels a journey between said entry point and said exit point; and,
for a predefined pathway, maintaining the speed of each authorized vehicle on said predefined pathway at a predetermined minimum speed to thereby maximize the amount of traffic flow on that predefined path.
Another aspect of the invention is that it is a transportation system comprising:
a defined transportation universe having defined contents and a defined transportation universe boundary;
a central control system for controlling the transportation universe;
a plurality of vehicles having a vehicle identification unit authorized by said central control system and connectable in two-way data communication with said central control system and is therefore an authorized vehicle;
wherein each authorized vehicle in the transportation universe is controlled by said central computer system interacting with the identification unit in said vehicle;
wherein each authorized vehicle is motor powered so as to be self-movable within the transportation universe under the control of said central control system;
wherein each of said authorized vehicles can enter into the transportation universe through the transportation universe boundary at one of a plurality of entry points and can exit from the transportation universe through the transportation universe boundary at one of a plurality of exit points;
wherein the entry of each vehicle into the transportation universe is authorized by said central control system;
wherein each of said plurality of vehicles that enters into and exits from the transportation universe boundary travels a journey between said entry point and said exit point; and,
wherein said central control system can allocate and reallocate the purpose of a predefined pathway in the transportation universe.
Another aspect of the invention is that it as transportation method comprising the steps of:
defining a transportation universe including contents thereof and a defined transportation universe boundary;
programming a central control system to control the transportation universe;
providing a plurality of vehicles with a vehicle identification unit authorized by said central control system and connectable in two-way data communication with said central control system, such that said vehicles become authorized vehicles, wherein each authorized vehicle is motor powered so as to be self-movable within the transportation universe under the control of said central control system;
controlling each authorized vehicle in the transportation universe using said central computer system;
permitting each of said authorized vehicles to enter into the transportation universe through the transportation universe boundary at one of a plurality of entry points and to exit from the transportation universe through the transportation universe boundary at one of a plurality of exit points;
wherein each of said plurality of vehicles that enters into and exits from the transportation universe boundary travels a journey between said entry point and said exit point; and,
for a predefined path, allocating and reallocating the purpose of a predefined pathway in the transportation universe.

A transportation system universe equipped to detect pedestrians, animals, weather conditions, or objects to protect the pedestrians and animals and to protect the vehicle occupants and contents from damage due to pedestrians, animals, objects, and weather.

Illustrated embodiments of this invention are described herein. Variations of those illustrated embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Further, nothing in the above-provided discussions of the transportation system and method should be construed as limiting the invention to a particular embodiment or combination of embodiments. The scope of the invention is defined by the appended claims.

1. A collaborative transportation system comprising:
a defined transportation universe having defined contents and a defined transportation universe boundary;
a central control system for controlling the transportation universe;
a plurality of vehicles having a vehicle identification unit authorized by said central control system and connectable in two-way data communication with said central control system and is therefore an authorized vehicle;
wherein each authorized vehicle in the transportation universe is controlled by said central computer system interacting with the identification unit in said vehicle;
wherein each authorized vehicle is motor powered so as to be self-movable within the transportation universe under the control of said central control system;
wherein each of said authorized vehicles can enter into the transportation universe through the transportation universe boundary at one of a plurality of entry points and can exit from the transportation universe through the transportation universe boundary at one of a plurality of exit points;
wherein the entry of each vehicle into the transportation universe is authorized by said central control system;
wherein each of said plurality of vehicles that enters into and exits from the transportation universe boundary travels a journey between said entry point and said exit point;
wherein no authorized vehicle in the transportation universe operates autonomously without the central control, and,
wherein each authorized vehicle is controlled along said journey in co-operation with each other authorized vehicle when in the transportation universe to thereby provide fully collaborative control of traffic in the transportation universe.
wherein the transportation universe boundary is defined by markers that are virtual or real.
wherein at least some journeys are at least partially pre-defined or alternately fully pre-defined.
wherein each authorized vehicle is controlled along said journey in co-operation with each other authorized vehicle when in the transportation universe by way of automatically spacing each vehicle from the others.
wherein no authorized vehicle in the transportation universe operates autonomously without the central control.

2. The transportation system of claim 1, wherein each authorized vehicle is controlled along said journey in co-operation with each other authorized vehicle when in the transportation universe by way of automatically coupling (physically or spatially) together at least some of said vehicles together as said vehicles travel on their journeys.

3. The transportation system of claim 1 and its said central control system controls wherein a portion of said authorized vehicles on a journey in the transportation universe are defined as a flock of vehicles such that:
the travel of the flock as one unit wherein a portion of said authorized vehicles on a journey in the transportation universe defined as a flock of vehicles sharing at least a portion of their journeys to various destinations.
wherein a portion of said authorized vehicles on a journey in the transportation universe are defined as a flock of vehicles and said central control system controls the travel of the flock as one unit along the entirety of their journeys.
wherein each of said vehicles in said flock of vehicles has a common “locality” destination with the others.
wherein the number of vehicles in said flock of vehicles changes during said journey.
wherein an authorized vehicle can be requested to leave a flock at any time during the journey of said authorized vehicle.
wherein said authorized vehicle can be requested to leave a flock at any time during the journey of said authorized vehicle via said central control system.
wherein said authorized vehicle can be requested to leave a flock at any time during the journey of said authorized vehicle by a user within said authorized vehicle.
wherein an authorized vehicle can be commanded to leave a flock at any time during the journey of said authorized vehicle.
wherein the transportation universe includes streets and street intersections, and wherein the journey of a first flock and the journey of the second flock that pass through a common intersection are each timed to preclude physical interference of each flock with the other.

4. The transportation system of claim 1, further comprising personal identification units authorized by said central control system and connected in two-way data communication with said central control system, for carrying by individuals entering the transportation universe without a vehicle.

5. The transportation system of claim 1, wherein said personal identification units include a portable data device and or communication device, a physical sensor, a visually readable code.

6. The transportation system of claim 1, further comprising sensors monitoring the transportation universe and connected to said central control system for detecting unauthorized objects in the transportation universe and providing an object alert to said central control system regarding detected objects.

7. The transportation system of claim 1, wherein some of said authorized vehicles are privately owned vehicles, some of said authorized vehicles are corporately owned vehicles, and some of said authorized vehicles are publicly owned vehicles.

8. The transportation system of claim 1, wherein said user starts a journey at the entry point to the transportation universe.

9. The transportation system of claim 1, further comprising a route evaluation system for evaluating the effectiveness of travelled routes of journeys and producing a route evaluation for various journeys, and comparing various evaluations to develop route optimization data.

10. The transportation system of claim 1, wherein said central control system can allocate and reallocate the purpose of a predefined pathway in the transportation universe.

11. The transportation system of claim 1, wherein said central control system can dynamically allocate and dynamically reallocate the purpose of a predefined pathway in the transportation universe.

12. The transportation system of claim 1, wherein said central control system can gather environmental data from at least some of said authorized vehicles.

13. The transportation system of claim 1, wherein said central control system can use said environmental data to determine the route of an authorized vehicle.

14. The transportation system of claim 1, wherein said central control system can preset the travel speed of vehicles on a predefined pathway and allow the entry of vehicles according to the amount of traffic said predefined pathway.

15. A transportation method comprising the steps of:
defining a transportation universe including contents thereof and a defined transportation universe boundary;
programming a central control system to control the transportation universe;
providing a plurality of vehicles with a vehicle identification unit authorized by said central control system and connectable in two-way data communication with said central control system, such that said vehicles become authorized vehicles, wherein each authorized vehicle is motor powered so as to be self-movable within the transportation universe under the control of said central control system;
controlling each authorized vehicle in the transportation universe using said central computer system;
permitting each of said authorized vehicles to enter into the transportation universe through the transportation universe boundary at one of a plurality of entry points and to exit from the transportation universe through the transportation universe boundary at one of a plurality of exit points;
wherein each of said plurality of vehicles that enters into and exits from the transportation universe boundary travels a journey between said entry point and said exit point; and,
controlling each of said authorized vehicles along said journey in co-operation with each other authorized vehicle when in the transportation universe to thereby provide fully collaborative control of traffic in said transportation universe.

16. A transportation system comprising:
a defined transportation universe having defined contents and a defined transportation universe boundary;
a central control system for controlling the transportation universe;
a plurality of vehicles having a vehicle identification unit authorized by said central control system and connectable in two-way data communication with said central control system and is therefore an authorized vehicle;
wherein each authorized vehicle in the transportation universe is controlled by said central computer system interacting with the identification unit in said vehicle;
wherein each authorized vehicle is motor powered so as to be self-movable within the transportation universe under the control of said central control system;
wherein each of said authorized vehicles can enter into the transportation universe through the transportation universe boundary at one of a plurality of entry points and can exit from the transportation universe through the transportation universe boundary at one of a plurality of exit points;
wherein the entry of each vehicle into the transportation universe is authorized by said central control system;
wherein each of said plurality of vehicles that enters into and exits from the transportation universe boundary travels a journey between said entry point and said exit point; and,
wherein, for a predefined path, each authorized vehicle on said predefined pathway is maintained at a predetermined minimum speed to thereby maximize the amount of traffic flow on that predefined path.
